(19) United States
(12) Patent Application Publication
(10) Pub. No.: US 2018/0259086 A1
(43) Pub. Date: Sep. 13, 2018

(54) Butterfly Valve Comprising Removable Coupling Part

(71) Applicant: Frank Borge, Hauglandshella (NO)

(72) Inventor: Frank Borge, Hauglandshella (NO)

(21) Appl. No.: 15/977,892

(22) Filed: May 11, 2018

Related U.S. Application Data
(63) Continuation-in-part of application No. 14/766,174, filed on Aug. 6, 2015, now abandoned.

(30) Foreign Application Priority Data
Feb. 6, 2013 (NO) 20130199

(51) Int. Cl. F16K 27/02; F16K 1/226

(52) U.S. Cl. CPC F16K 27/0218; F16K 1/2265

(57) ABSTRACT

A soft-sealing, concentric butterfly valve for mounting with grooved couplings or flanges in a pipe system. The butterfly valve comprising a valve housing with a through running boring with a rotary damper, mounted to a spindle placed upright in a circular-cylindrical valve seat, said valve seat being equipped internally with conical contact surfaces for the damper, and the valve housing comprises on a first side a coupling end piece cast in one piece with the valve housing and equipped with an external circular groove. The valve has a removable coupling part, comprising a second coupling end piece equipped with an external circular groove, mounted to said second side of the valve housing, and said valve seat is compressed between the valve housing and the removable coupling part and surrounds the damper to provide a leak proof connection.

This application claims priority under 35 USC 120 and is a CIP of U.S. application Ser. No. 14/766,174, filed Aug. 6, 2015, which in turn claims priority under 35 USC §§ 365 and 371 to PCT/NO2014/000013, filed Feb. 4, 2014, which in turn claims priority to NO 20130199, filed Feb. 6, 2013, all of which are incorporated by reference in their entireties

### BACKGROUND OF THE INVENTION

The present invention relates to a soft-sealing, concentric butterfly valve for mounting with grooved couplings of a pipe system. The invention also relates to a pipe alignment system, and a method for alignment of a first pipe and a second pipe in a pipe system.

Today, it is common to use lug type butterfly valves with threaded bore holes on both sides of the valve. This is a well tried embodiment which is approved by the classification associations. However, the mounting is labour intensive as one must first weld flanges onto the pipe ends. Thereafter, the valve is centred on the flange and bolts are tightened. The most common valves are also vulnerable to poor centring or damages to the flange. If the mounting procedures are not followed accurately, there will be a risk for leaks and damages.

In addition, this is a time consuming and thus a costly procedure. On a modern PSV vessel (platform supply ship), there are about 250 tonnes of pipe and pipe parts so that the piping work is one of the most labour intensive and costly jobs for a such new construction, and particularly within the ship building industry there is a considerable saving potential.

Couplings have been on the market for many years, but have mainly been used within fire protection/sprinklers and plumbing, heating and sanitation. There has been only limited industrial application before now, as shipyards have started to use couplings to a larger extent. Focus on savings in time and thereby costs have provided an opening for this type of equipment.

As mentioned, there are today a good selection of equipment and parts for fire protection/sprinklers and plumbing, heating and sanitation, including valves suitable for such application areas. However, there are no valves for this type of coupling that is suitable for use within ship building and the market is asking for such valves. The valve according to the invention has a particular application within the ship building industry, but can be used in general within any industry and is thus not limited to the ship building industry.

All the known valves for fitting with couplings have in common that the sealing is in the form of a vulcanised rubber covering on the damper. The valve housing is covered with an epoxy compound or similar surface treatment. This makes the valve vulnerable to damages in the covering, both in the valve housing and on the damper. The risk of corrosion and subsequent leakage is regarded as relatively large.

Valve types with coupling ends on both sides are not suited for mounting to the side of a ship. A number of standard lug valves are used together with flange adapters for the fitting. This is expensive equipment and not particularly suited to fitting of standard dampers.

The valve according to the invention is a soft-sealing, concentric butterfly valve which is leak proof, often with a two-sided seal. Furthermore, it can have a through running spindle fastened to the damper via a spline, square peg or taper pins. Thus, providing a dry spindle, isolated from the medium.

The components of the soft-sealing butterfly valve according to the invention are placed in an improved valve housing with an end piece for mounting to a coupling, such as a mechanical grooved coupling in a pipe system. It is thus not a quick coupling, but a fast mechanical connection with bolts that are tightened to secure the coupling. Examples of pressure classification can be up to 64 bar for the coupling and 25 bar for the valve.

A valve seat of different materials can be mounted on or vulcanised on a hard insertion ring or support ring. The valve seat can have conical contact surfaces for the damper at the through running of the spindle and also integrated sealing rings in the opening for the running through of the spindle. This ensures a leak proof construction without the use of extra O-rings.

The valve can have a metal damper in different materials with a machined sealing surface.

The butterfly valve according to the invention is preferably cast in two parts. A main part, i.e. the valve housing can have an end pipe piece for a coupling on one side and a standard lug embodiment with threaded bolt holes on the other side. At mounting of the lug side against a flange, the valve will be able to be mounted to the side of the ship, to flanged pipe parts or components such as filters, pumps, etc. Mounted on this way the valve can function as a blinding of a pipe line.

According to the invention the butterfly valve has a second removable coupling part in the form of a flanged pipe end piece where the flange boring is adapted to the boring of the lug side of the valve. The pipe end is preferably grooved for mounting with couplings. The valve housing can have an ISO standardised top flange that makes a direct fitting of an activator possible. The valve housing has a standard short neck, but can be supplied with a long neck adapted to the isolation of pipelines.

A valve according to the invention can have a type of valve seat that seals against a counter flange without the use of additional gaskets. The contact edge or surface in the main part of the valve housing can function as a sealing surface. When the removable coupling part or a standard counter flange is mounted to the main part of the valve housing, the valve seat is compressed between these parts so that a leak proof connection is created in all joints.

Consequently, it is an object to provide a valve and then in particular a butterfly valve as described above. It is also an object to provide a pipe alignment system, and a method for alignment of a first pipe and a second pipe in a pipe system.

From prior art, reference is made to, among others, U.S. Pat. No. 6,125,871 A which shows a chemical fluid transfer valve (for example, for loading/unloading of bulk materials) and which is formed by a male valve assembly and a female valve assembly. This relates to a composed sampling valve with a flushing solution based on loose components and quick couplings. The butterfly valve is here a standard wafer valve for insertion between the flanges.

U.S. 2011163532 A1 show a hose coupling for a fire engine and a method for the use of the system. The hose coupling is in the form of a quick coupling that makes it possible to get a quick connection between the fire hose and the fire engine, and even more importantly is that the system makes it possible to disconnect even faster.

The above mentioned documents relates in general to quick couplings. The present invention relates, as mentioned, not to a quick coupling, which will be clear in the sense that the valve housing and the removable coupling part shall be screwed together, i.e. a solid mechanical connection with bolts that are tightened to secure the coupling. Furthermore, the valve according to the invention is a soft-sealing, concentric butterfly valve which is leak proof, usually with a two-sided seal.

Reference is also made to U.S. Pat. No. 2,974,921 A, U.S. 31518374, and U.S. Pat. No. 3,656,714A, which all relates to butterfly valves.

### SUMMARY OF THE INVENTION

According to a first aspect of the invention, a butterfly valve for grooved couplings in a pipe system is disclosed, the butterfly valve comprising a valve housing with a through running boring, and a rotary damper, mounted to a spindle, placed upright in a circular-cylindrical valve seat in the valve housing. The valve housing comprises on a first side of the through running boring a first coupling end piece cast in one piece together with the valve housing and which is equipped with an external circular groove for connection with a first grooved coupling in the pipe system, and the valve housing comprises on a second side of the through running boring a removable coupling part with a second coupling end piece which is equipped with an external circular groove for connection with a second grooved coupling in the pipe system, said removable coupling part has a through running boring aligned with the through running boring of the valve housing, The valve seat is equipped internally with respective conical contact surfaces for sealing receipt of the rotary damper, wherein said valve seat is compressed between the valve housing and the removable coupling part and surrounds the damper to provide a soft-sealing and concentric butterfly valve with a leak proof connection.

The spindle can run through the valve seat, and the valve seat can comprise integrated sealing rings for the spindle.

The removable coupling part mounted on the second side of the valve housing comprises preferably a boring with the same diameter as the boring in the valve housing.

The valve housing can be equipped with a neck comprising a collar, wherein an upper part of the spindle extends up above the collar to provide a rotating pivot point for an activator.

The valve housing may comprise, on one or both sides of the damper, bushes or bearings for mounting of the spindle.

The valve seat can be compressed between an internal surface of the valve housing and an external surface of the removable coupling part to provide said leak proof connection.

The butterfly valve can surface treated with hot-dip galvanising.

Further, the valve housing may comprise on the second side several threaded bolt holes radially around the through running boring, and the removable coupling part can be connected to the valve housing by bolts inserted in the threaded bolt holes.

In one embodiment the rotatable damper can be made of metal without any covering and the valve seat can be made of rubber.

According to a second aspect of the invention a pipe alignment system is disclosed, comprising a first pipe, a second pipe, and a butterfly valve. Said butterfly valve comprises a valve housing with a through running boring, and a rotary damper, mounted to a spindle, placed upright in a circular-cylindrical valve seat in the valve housing. The valve housing comprises on a first side of the through running boring a first coupling end piece cast in one piece together with the valve housing and which is equipped with an external circular groove for connection with a first coupling groove of the first pipe, and the valve housing comprises on a second side of the through running boring a removable coupling part with a second coupling end piece which is equipped with an external circular groove for connection with a second coupling groove of the second pipe, said removable coupling part has a through running boring aligned with the through running boring of the valve housing. The valve seat is equipped internally with respective conical contact surfaces for sealing receipt of the rotary damper, wherein said valve seat is compressed between the valve housing and the removable coupling part and surrounds the damper to provide a soft-sealing and concentric butterfly valve with a leak proof connection. The external circular groove of the first coupling end piece is connected with the first coupling groove of the first pipe by a first clamp, and the external circular groove of the second coupling end piece is connected with the second coupling groove of the second pipe by a second clamp.

In the pipe alignment system a first gasket can cover the external grooved couplings of the first coupling end piece and the first pipe, and a second gasket can cover the external grooved couplings of the second coupling end piece and the second pipe.

Said first and second clamps can each comprise two half circular and connectable clamp parts.

According to a third aspect of the invention, a method for alignment of a first pipe and a second pipe in a pipe system is disclosed, comprising placing a butterfly valve between said first pipe and said second pipe, wherein the butterfly valve comprises: a valve housing with a through running boring, and a rotary damper, mounted to a spindle, placed upright in a circular-cylindrical valve seat in the valve housing. The valve housing comprises on a first side of the through running boring a first coupling end piece cast in one piece together with the valve housing and which is equipped with an external circular groove, and the valve housing comprises on a second side of the through running boring a removable coupling part with a second coupling end piece which is equipped with an external circular groove, said removable coupling part has a through running boring aligned with the through running boring of the valve housing. The valve seat is equipped internally with respective conical contact surfaces for the rotary damper, wherein said seat is compressed between the valve housing and the removable coupling part and surrounds the damper to provide a soft-sealing concentric butterfly valve with a leak proof connection. The method further comprises the steps of connecting the external circular groove of the first coupling end piece with a first coupling groove of the first pipe using a first clamp, and connecting the external circular groove of the second coupling end piece with a second coupling groove of the second pipe using a second clamp.

The method can comprise placing a first gasket covering the external grooved couplings of the first coupling end piece and the first pipe, and placing a second gasket covering the external grooved couplings of the second coupling end piece and the second pipe.

The method may further comprise assembling said first and second clamps covering respective first and second gaskets.

### BRIEF DESCRIPTION OF THE DRAWINGS

The invention shall now be described in more detail with help of the enclosed figures, in which

FIG. 1 shows an outline of a butterfly valve according to the invention.

FIG. 2 shows a section of the butterfly valve according to the invention.

FIG. 3 shows a top outline of the butterfly valve shown in FIGS. 1 and 2.

FIG. 4 shows an outline of a removable coupling part according to the invention.

FIG. 5 shows a section of the removable coupling part according to the invention.

FIG. 6 shows an outline of the butterfly valve according to the invention.

FIG. 7 shows a section of the butterfly valve according to the invention.

FIG. 8 shows an exploded view of a pipe alignment system according to the invention, and with a butterfly valve.

FIG. 9 shows the pipe alignment system of FIG. 8 assembled.

### DESCRIPTION OF THE PREFERRED EMBODIMENTS

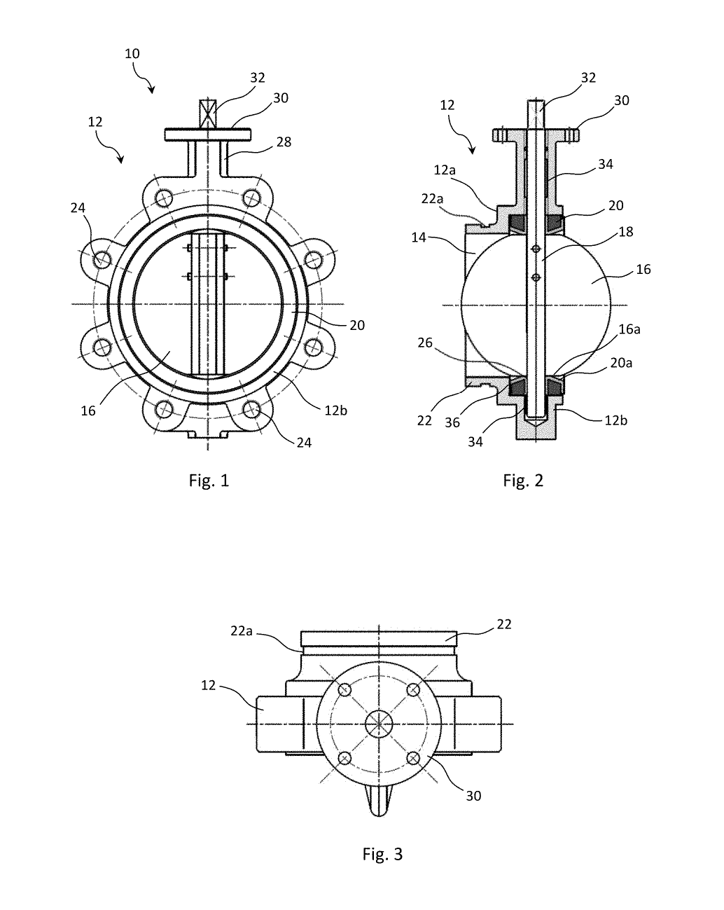

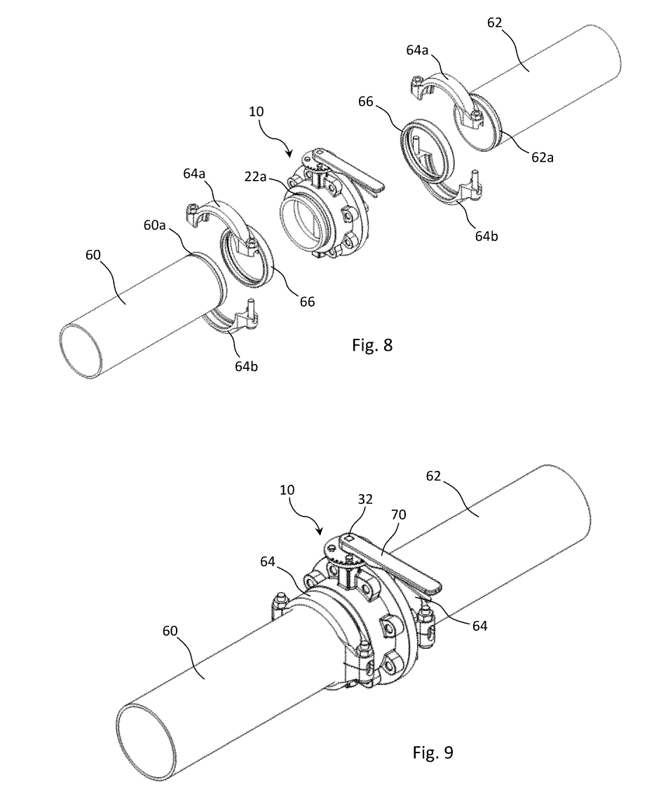

FIGS. 1-3 show a valve housing 12 of a butterfly valve 10 according to the invention. The valve housing 12 comprises a spindle 18 that extends vertically through most of the valve housing 12. A damper 16 is arranged upright or standing in a through running boring 14, in where the damper 16 is mounted to the spindle 18. The spindle 18, and thus the damper 16, can be rotated either manually or automatically with the help of an activator 70, as shown in FIGS. 8 and 9. The activator 70 can be a handle or any electro-mechanical unit capable of rotating the spindle 18. For example, an upper end 32 of the spindle 18 that extends out of or extends above the valve housing 12 can function as a rotation pivot and is activated for rotation of the damper 16 so that flow through the valve housing is permitted and regulated. The valve housing 12 can comprise, on one or both sides of the damper 16, bushes or bearings 34 for the mounting of the spindle 18.

Furthermore, a valve seat 20 is arranged in the boring 14 and surrounds the damper 16, where the valve seat can be formed with a basically circular-cylindrical form and in various materials and which can be cast in a sealing material and/or which can be fitted with or vulcanised on a hard insert ring or support ring (for example, as illustrated in FIG. 2). The valve seat 20 can have conical contact surfaces 20a for the damper 16 at the through running of the spindle and also integrated sealing rings 26. The valve seat 20 can also be cast, for example, in one piece of plastic or rubber. Furthermore, the valve seat 20 lies against an inner edge 36 in the valve housing 12 and a second removable coupling part 40 can provide a corresponding surface 38 which the valve seat 20 can lie against.

In one embodiment the damper 16 is made of metal and the valve seat 20 is made of rubber. The damper 16 is not provided with any covering, such as for instance vulcanised rubber, for sealing between the damper and the valve seat.

As seen in particularly FIGS. 2 and 7 the conical contact surfaces 20a of the valve seat 20 are bevelled or chamfered with an increasing diameter towards each side of the opening in the valve seat 20.

The damper 16 is formed, basically with a circular shape with an external diameter that corresponds with the inner diameter of the valve seat 20, but where the damper 16 at the through running of the spindle 18 is formed with respective bevelled and flat top and bottom sections 16a.

The upper part of the valve housing 12 can comprise, in a known way, a neck 28 and a top flange 30.

A first side 12a of the valve housing 12 comprises a coupling end piece 22 for connection in a pipe system and comprises an external circular coupling groove 22a. A second side 12b of the valve housing 12 comprises a coupling surface with for instance several threaded bolt holes 24 arranged radially about the boring 14. Thereby, the butterfly valve 10 as shown in FIGS. 1-3, can be connected to a coupling on one side and to a standard flange connection (not shown), or the like, of a pipe on the other side.

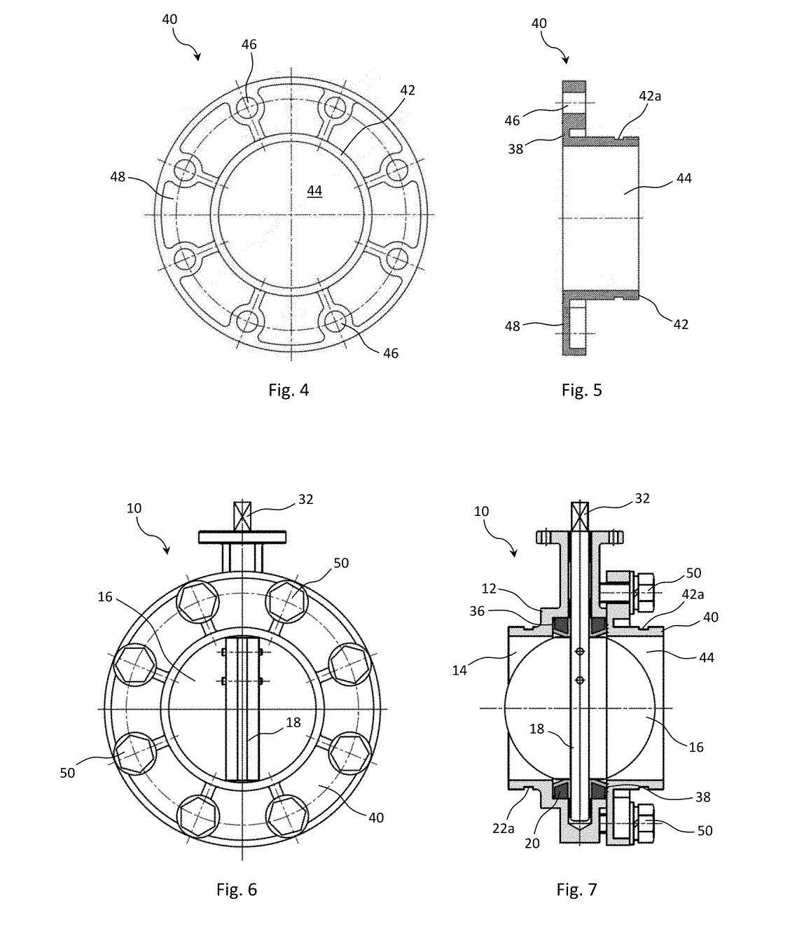

FIGS. 4 and 5 show a second removable coupling part 40 for use together with the valve housing 12. The removable coupling part 40 comprises a pipe piece in the form of a coupling end piece 42 for connecting in a pipe system. In a corresponding way, the coupling end piece 42 can be equipped with an external circular coupling groove 42a. The coupling part 42 further comprises a flange-like connection 48 equipped with several bolt holes 46, where the placing of the bolt holes 46 corresponds to the bolt holes 24 in the valve housing 12, i.e. with the same radial centreline. The removable coupling part 40 comprises a through running boring 44 with the same diameter as the through running boring 14 in the valve housing 12.

FIGS. 6 and 7 show the removable coupling part 40 mounted to the valve housing 12. In this preferred embodiment the butterfly valve according to the invention can be used between two couplings in a pipe system. As shown in the figures, the removable coupling part 40 is securely bolted with the help of the bolts 50 that run through the bolt holes 24 in the flange part 48 of the removable coupling part 40 and which are screwed into the threaded bolt holes 24 of the valve housing 12. Thus, this provides a butterfly valve with two opposite coupling ends 22,42. Alternatively, the coupling part 40 can be fastened in other ways or with other means to the valve housing 12 than those shown in the figures. It can also be imagined that the coupling part can be cast integrated with the valve housing in one piece.

The valve seat 20 lies, as shown, against an inner edge or surface 36 in the valve housing 12 and the second removable coupling part 40 provides a corresponding edge or surface 38 against which the valve seat 20 lies. Thus, the valve seat 20 is inserted between the valve housing 12 and the removable coupling part 40 and surrounds the damper 16. Thereby, the valve seat 20 seals without the use of an additional gasket as the surface 36 in the valve housing 12 and the contact surface 38 of the removable coupling part 40 can function as sealing surfaces so that the valve seat 20 is compressed between these two parts and a watertight connection in all joints is achieved. The corresponding will be relevant at the use of a standard flange connection instead of the second coupling part, as described above.

Furthermore, the valve seat will be able to isolate the valve housing, which may contribute to reduce internal wear in the valve housing.

The butterfly valve 10 can be supplied in a hot-dip galvanized embodiment. In, for example, a ballast system, hot-dip galvanisation is a common surface treatment of components. The valve 10 with the coupling ends 22,42 is both a valve and a piece of the pipe system and a corresponding surface treatment of the valve could therefore be an important feature. Previously, it has not been common that valves for use in such pipe systems have been supplied in hot-dip galvanised embodiments.

It shall also be mentioned that the coupling parts 22,42 can alternatively be connected to the pipes in the pipe system with the help of a loop coupling, i.e. a loop that can be tightened with the help of a rotary lifting arm and is securely locked in a tightened position. The intended loop coupling is not a real quick coupling, but a coupling intended for use in installation areas where pipe routes are often re-laid.

FIG. 8 shows a pipe alignment system comprising a first pipe 60, a second pipe 62, and the butterfly valve 10 as disclosed previously.

Said butterfly valve 10 comprises the valve housing 12 with the through running boring 14, the rotary damper 16 mounted to the spindle 16 placed upright or standing in the circular-cylindrical valve seat 20 in the valve housing 12. The valve housing 12 comprises on a first side of the through running boring 14 the first coupling end piece 22 cast in one piece together with the valve housing 12 and is equipped with the external circular groove 22a for connection with a first coupling groove 60a of the first pipe 60. The valve housing 12 comprises on a second side of the through running boring 14 the removable coupling part 40 with the second coupling end piece 42 equipped with the external circular groove 42a for connection with a second coupling groove 62a of the second pipe 62. The valve seat 20 is as mentioned equipped internally with respective conical contact surfaces 20a for the rotary damper, wherein said valve seat 20 is compressed between the valve housing 12 and the removable coupling part 40 and surrounds the damper 16 to provide a soft-sealing and concentric butterfly valve with a leak proof connection.

The external circular groove 22a of the first coupling end piece 22 is connected with the first coupling groove 60a of the first pipe 60 by a first clamp 64, and the external circular groove 42a of the second coupling end piece 42 is connected with the second coupling groove 62a of the second pipe 62 by a second clamp 64.

Preferably is a first gasket 66 covering the external grooved couplings 22a,60a of the first coupling end piece 22 and the first pipe 60, and a second gasket 66 covers the external grooved couplings 42a,62a of the second coupling end piece 42 and the second pipe 62. To provide easier assembling of the clamps 64, the first and second clamps 64 comprise each two half circular and connectable clamp parts 64a,64b.

According to the invention the butterfly valve 10 is thus placed between said first pipe 60 and said second pipe 60, and the external circular groove 22a of the first coupling end piece 22 is connected to the first coupling groove 60a of the first pipe 60 using a first clamp 64, and the external circular groove 42a of the second coupling end piece 42 is connected to the second coupling groove 62a of the second pipe 62 using a second clamp 64.

1. A butterfly valve for grooved couplings in a pipe system, the butterfly valve comprising:
a valve housing with a through running boring,
a rotary damper, mounted to a spindle, placed upright in a circular-cylindrical valve seat in the valve housing,
the valve housing comprises on a first side of the through running boring a first coupling end piece cast in one piece together with the valve housing and which is equipped with an external circular groove for connection with a first grooved coupling in the pipe system,
the valve housing comprises on a second side of the through running boring a removable coupling part with a second coupling end piece which is equipped with an external circular groove for connection with a second grooved coupling in the pipe system, said removable coupling part has a through running boring aligned with the through running boring of the valve housing, and
said valve seat is equipped internally with respective conical contact surfaces for sealing receipt of the rotary damper, wherein said valve seat is compressed between the valve housing and the removable coupling part and surrounds the damper to provide a soft-sealing and concentric butterfly valve with a leak proof connection.

2. The butterfly valve according to claim 1, wherein the spindle runs through the valve seat, and the valve seat comprises integrated sealing rings for the spindle.

3. The butterfly valve according to claim 1, wherein the removable coupling part mounted on the second side of the valve housing comprises a boring with the same diameter as the boring in the valve housing.

4. The butterfly valve according to claim 1, wherein the valve housing is equipped with a neck comprising a collar, wherein an upper part of the spindle extends up above the collar to provide a rotating pivot point for an activator.

5. The butterfly valve according to claim 1, wherein the valve housing comprises, on one or both sides of the damper, bushes or bearings for mounting of the spindle.

6. The butterfly valve according to claim 1, wherein the valve seat is compressed between an internal surface of the valve housing and an external surface of the removable coupling part to provide said leak proof connection.

7. The butterfly valve according to claim 1, wherein the butterfly valve is surface treated with hot-dip galvanising.

8. The butterfly valve according to claim 1, wherein the valve housing comprises on the second side several threaded bolt holes radially around the through running boring, and the removable coupling part is connected to the valve housing by bolts inserted in the threaded bolt holes.

9. The butterfly valve according to claim 1, wherein the rotatable damper is made of metal without any covering and the valve seat is made of rubber.

10. A pipe alignment system, comprising:
a first pipe,
a second pipe,
a butterfly valve, said butterfly valve comprises:
a valve housing with a through running boring,
a rotary damper, mounted to a spindle, placed upright in a circular-cylindrical valve seat in the valve housing,
the valve housing comprises on a first side of the through running boring a first coupling end piece cast in one piece together with the valve housing and which is equipped with an external circular groove for connection with a first coupling groove of the first pipe,
the valve housing comprises on a second side of the through running boring a removable coupling part with a second coupling end piece which is equipped with an external circular groove for connection with a second coupling groove of the second pipe, said removable coupling part has a through running boring aligned with the through running boring of the valve housing, and
said valve seat is equipped internally with respective conical contact surfaces for sealing receipt of the rotary damper, wherein said valve seat is compressed between the valve housing and the removable coupling part and surrounds the damper to provide a soft-sealing and concentric butterfly valve with a leak proof connection, wherein
the external circular groove of the first coupling end piece is connected with the first coupling groove of the first pipe by a first clamp, and
the external circular groove of the second coupling end piece is connected with the second coupling groove of the second pipe by a second clamp.

11. The pipe alignment system of claim 10, wherein a first gasket covers the external grooved couplings of the first coupling end piece and the first pipe, and a second gasket covers the external grooved couplings of the second coupling end piece and the second pipe.

12. The pipe alignment system of claim 10, wherein said first and second clamps each comprises two half circular and connectable clamp parts.

13. A method for alignment of a first pipe and a second pipe in a pipe system, comprising:
placing a butterfly valve between said first pipe and said second pipe, wherein the butterfly valve comprises:
a valve housing with a through running boring,
a rotary damper, mounted to a spindle, placed upright in a circular-cylindrical valve seat in the valve housing,
the valve housing comprises on a first side of the through running boring a first coupling end piece cast in one piece together with the valve housing and which is equipped with an external circular groove,
the valve housing comprises on a second side of the through running boring a removable coupling part with a second coupling end piece which is equipped with an external circular groove, said removable coupling part has a through running boring aligned with the through running boring of the valve housing, and
said valve seat is equipped internally with respective conical contact surfaces for the rotary damper, wherein said seat is compressed between the valve housing and the removable coupling part and surrounds the damper to provide a soft-sealing concentric butterfly valve with a leak proof connection, wherein the method further comprises the steps:
connecting the external circular groove of the first coupling end piece with a first coupling groove of the first pipe using a first clamp, and
connecting the external circular groove of the second coupling end piece with a second coupling groove of the second pipe using a second clamp.

14. The method of claim 13, wherein the method further comprises placing a first gasket covering the external grooved couplings of the first coupling end piece and the first pipe, and placing a second gasket covering the external grooved couplings of the second coupling end piece and the second pipe.

15. The method of claim 14, wherein the method further comprises assembling said first and second clamps covering respective first and second gaskets.
